(19) United States
(12) Patent Application Publication
(10) Pub. No.: US 2009/0113254 A1
(43) Pub. Date: Apr. 30, 2009

(54) System management apparatus and method for multi-shelf modular computing system

(76) Inventor: CHI-CHUAN CHEN, Taipei County (TW)

Correspondence Address: REED SMITH LLP;Suite 1400, 3110 Fairview Park Drive, Falls Church, VA, 22042, US

(21) Appl. No.: 12/149,038

(22) Filed: Apr. 25, 2008

(30) Foreign Application Priority Data
Oct. 26, 2007 (TW) 096140172

(51) Int. Cl. G06F 11/32; G06F 11/07

(52) U.S. Cl. 714/49; 714/E11.187; 714/E11.021

(57) ABSTRACT

The invention provides a system management apparatus for a multi-shelf modular computing system. The system management apparatus receives and parses an alert information in response to an abnormal parameter/state relative to a component of the multi-shelf modular computing system sent from a shelf management device of the multi-shelf modular computing system, and stores the parsed alert information into a storage module. Then, the system management apparatus periodically retrieves the parsed alert information, if any, from the storage module and generates a visual alert information indicating the abnormal parameter/state. Thereby, a user can view the visual alert information to perceive the abnormal parameter/state rapidly and intuitively, so as to take corresponding measures.

### BACKGROUND OF THE INVENTION

1. Field of the Invention

The invention relates to a system management apparatus and method and, more particularly, to a system management apparatus and method for a multi-shelf modular computing system.

2. Description of the Prior Art

According to PCI Industrial Computers Manufacturers Group (PICMG) 3.0, when a multi-shelf modular computing system complying with an Advanced Telecom Computing Architecture (ATCA) specification has an abnormal situation occurred, a corresponding shelf management device would generate an alert information in a Simple Network Management Protocol (SNMP) trap format and transmit the alert information to a receiving apparatus of a predetermined target address.

Conventionally, the receiving apparatus can execute a receiving software program for receiving the alert information from the shelf management device, parsing the alert information, and displaying the parsed alert information in a text format on the receiving apparatus. Thereby, a user can perceive the abnormal situation of the multi-shelf modular computing system and take corresponding measures.

Nevertheless, the user has to further consult ATCA specification to understand the parsed alert information in the text format, which is very inconvenient for the user. Besides, since the alert information is displayed in text format, when the receiving apparatus receives too much alert information in a short time, owing to the size of display screen of the receiving apparatus and the excessive text information, earlier alert information would easily be ignored and therefore the abnormal situation of the system could not be handled in time. Furthermore, because the receiving software program executed by the receiving apparatus is not cross-platform capable, so its utilization is limited by compatibility.

Accordingly, a scope of the invention is to provide a system management apparatus for a multi-shelf modular computing system to solve the aforesaid problems.

### SUMMARY OF THE INVENTION

A scope of the invention is to provide a system management apparatus and method for a multi-shelf modular computing system. At first, the system management apparatus receives and parses alert information associated with an abnormal parameter/state related to a component of the multi-shelf modular computing system, and stores the parsed alert information in a storage module. Afterward, the system management apparatus periodically retrieves the parsed alert information, if any, from the storage module, and generates a visual alert information indicative of the abnormal parameter/state. Thereby, a user can view the visual alert information to perceive the abnormal parameter/state rapidly and intuitively, so as to take corresponding measures. In addition, since the alert information can be stored in the storage module, the many alert information generated within a short time can be kept and the earlier alert information will not be neglected.

According to an embodiment of the invention, the system management apparatus is for a multi-shelf modular computing system. In the embodiment, the multi-shelf modular computing system includes a plurality of components and a shelf management device. The shelf management device is capable of sensing a plurality of parameters/states which each relates to one of the components, and of generating an original alert information in a first format in response to an abnormal one among the sensed parameters/states.

The system management apparatus includes a receiving module, a storage module, a parsing module, a visualization mapping module, and a management module. The receiving module is capable of communicating with the shelf management device, for receiving the original alert information in the first format from the shelf management device. The parsing module is coupled to the receiving module and the storage module, respectively, for parsing the original alert information to generate a parsed alert information in a second format, and for storing the parsed alert information into the storage module. The visualization mapping module is coupled to the storage module, for periodically retrieving the parsed alert information, if any, from the storage module, and for generating a mapping indication in accordance with the retrieved parsed alert information. The management module is coupled to the visualization mapping module, for receiving the mapping indication, and for generating a visual alert information indicative of the abnormal one among the sensed parameters/states on the basis of the mapping indication.

According to another embodiment of the invention, the system management method is for a multi-shelf modular computing system. In the embodiment, the multi-shelf modular computing system includes a plurality of components and a shelf management device. The shelf management device is capable of sensing a plurality of parameters/states which each relates to one of the components, and generating an original alert information in a first format in response to an abnormal one among the sensed parameters/states.

In the embodiment, the system management method, firstly, communicates with the shelf management device. Then, the system management method receives the original alert information in the first format from the shelf management device. After that, the system management method parses the original alert information to generate a parsed alert information in a second format. Next, the system management method stores the parsed alert information. Afterward, the system management method periodically retrieves the parsed alert information, if any, and generates a mapping indication in accordance with the retrieved parsed alert information. Finally, the system management method receives the mapping indication and generates a visual alert information indicative of the abnormal one among the sensed parameters/states on the basis of the mapping indication.

Therefore, the system management apparatus and method of the invention is for a multi-shelf modular computing system. At first, the system management apparatus receives and parses alert information associated with an abnormal parameter/state related to a component of the multi-shelf modular computing system, and stores the parsed alert information in a storage module. Afterward, the system management apparatus periodically retrieves the parsed alert information, if any, from the storage module, and generates a visual alert information indicative of the abnormal parameter/state. Thereby, a user can view the visual alert information to perceive the abnormal parameter/state rapidly and intuitively, so as to take corresponding measures. In addition, since the alert information can be kept in the storage module, the many alert information generated within a short time can be stored and the earlier alert information will not be neglected. Furthermore, the system management apparatus can be web-based architecture with advantage of cross-platform capability which can lower the loading of client terminal apparatus.

The advantage and spirit of the invention may be understood by the following recitations together with the appended drawings.

### BRIEF DESCRIPTION OF THE APPENDED DRAWINGS

FIG. 1 shows a functional block diagram of the system management apparatus according to an embodiment of the invention.

FIG. 2A shows an example of the original alert information generated by the shelf management device as shown in FIG. 1.

FIG. 2B shows an example of the parsed alert information parsed by the parsing module as shown in FIG. 1.

FIG. 3 shows the visual alert information displayed in a user interface by a terminal apparatus as shown in FIG. 1.

FIG. 4 shows a flow chart of the system management method according to an embodiment of the invention.

### DETAILED DESCRIPTION OF THE INVENTION

This invention provides a system management apparatus and method for a multi-shelf modular computing system. At first, the system management apparatus receives and parses alert information associated with an abnormal parameter/state related to a component of the multi-shelf modular computing system, and stores the parsed alert information in a storage module. Afterward, the system management apparatus periodically retrieves the parsed alert information, if any, from the storage module, and generates a visual alert information indicative of the abnormal parameter/state. Thereby, a user can view the visual alert information to perceive the abnormal parameter/state rapidly and intuitively, so as to take corresponding measures. In addition, since the alert information can be stored in the storage module, the many alert information generated within a short time can be kept and the earlier alert information will not be neglected. Furthermore, the system management apparatus can be web-based architecture with the advantage of cross-platform capability which can lower the loading of client terminal apparatus. The spirit and feature of the present invention will be described in details with the following embodiments.

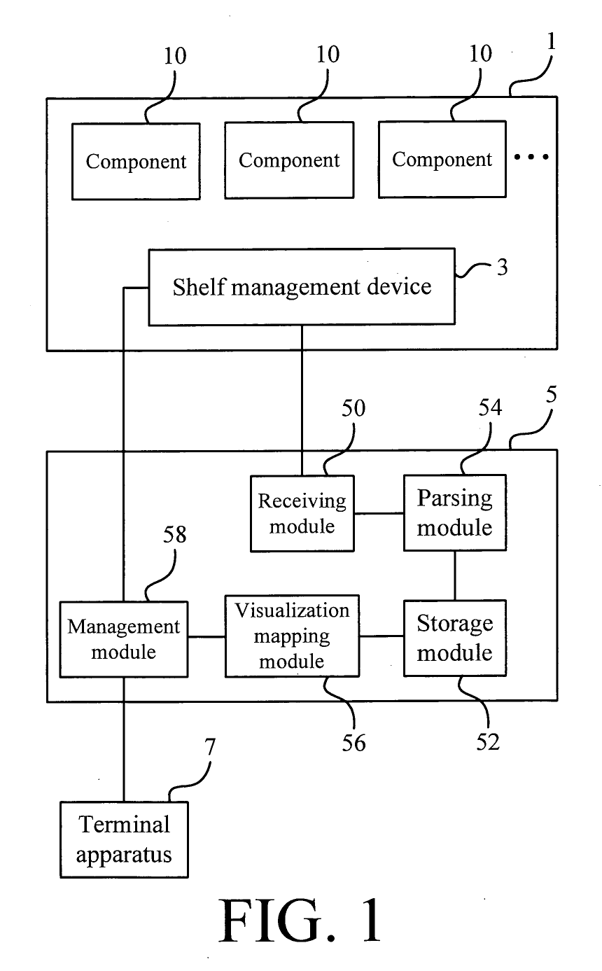

Please refer to FIG. 1. FIG. 1 shows a functional block of a system management apparatus 5 according to an embodiment of the invention. In the embodiment, the system management apparatus 5 is for a multi-shelf modular computing system 1. In practice, the multi-shelf modular computing system 1 can preferably, but not limited to, comply with an Advanced Telecom Computing Architecture (ATCA) specification which is a “carrier grade” communication equipment specification made by PCI Industrial Computer Manufacturers Group (PICMG). The multi-shelf modular computing system 1 includes a plurality of components 10 and a shelf management device 3. In actual applications, the components 10 can be the Field Replaceable Units (FRUs) of the multi-shelf modular computing system 1, such as single board computers, power supplies, fans, or thermal sensors. The shelf management device 3 is capable of sensing a plurality of parameters/states, which each relates to one of the components 10. In practice, the parameters/states include connection statuses of the single board computers, rotation rates of the fans, voltages of the power supplies, and the temperatures. The shelf management device 3 can also generate an original alert information in a first format in response to an abnormal one among the sensed parameters/states.

The system management apparatus 5 includes a receiving module 50, a storage module 52, a parsing module 54, a visualization mapping module 56, and a management module 58. In practice, the system management apparatus 5 can be implemented as a network server to achieve cross-platform applications.

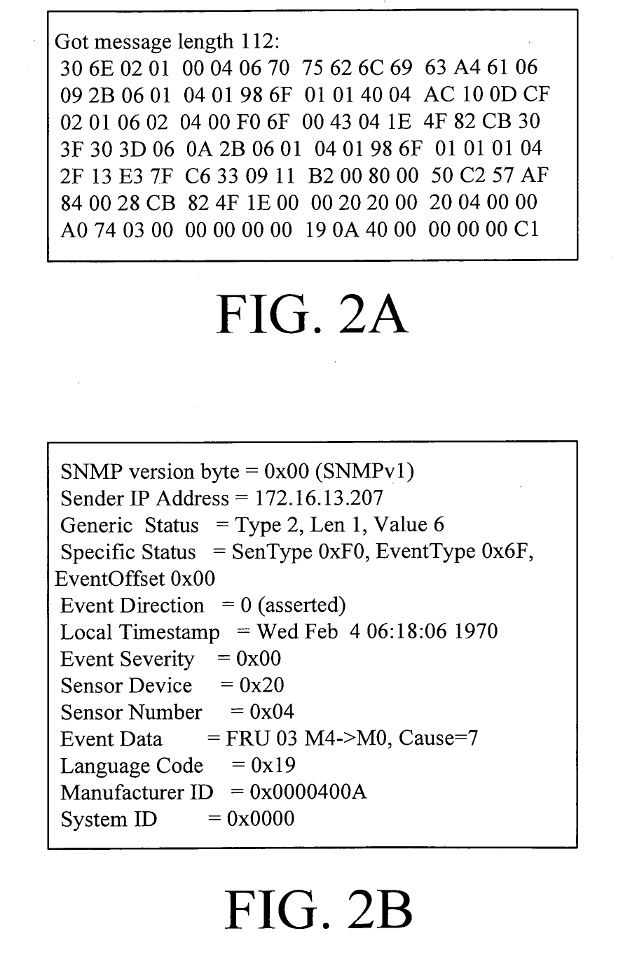

Please refer to FIG. 2A and FIG. 2B. FIG. 2A shows an example of the original alert information generated by the shelf management device 3 as shown in FIG. 1. FIG. 2B shows an example of the parsed alert information parsed by the parsing module 54 as shown in FIG. 1. The receiving module 50 is capable of communicating with the shelf management device 3, for receiving the original alert information in the first format from the shelf management device 3. In actual applications, the receiving module 50 communicates with the shelf management device 3 in a User Datagram Protocol (UDP) or a transmission control protocol (TCP). The parsing module 54 is coupled to the receiving module 50 and the storage module 52, respectively, for parsing the original alert information to generate a parsed alert information in a second format, and storing the parsed alert information into the storage module 52. In actual applications, the first format is a Simple Network Management Protocol (SNMP) trap format, and the second format is a user-readable format. For example, the original alert information in the first format, as shown in FIG. 2A, is difficult for people to understand. However, the parsed alert information, as shown in FIG. 2B, is more readable, but people still need to consult related reference data to specifically understand the meaning of the parsed alert information.

The visualization mapping module 56 is coupled to the storage module 52. The visualization mapping module 56 periodically retrieves the parsed alert information, if any, from the storage module 52, and generates a mapping indication in accordance with the retrieved parsed alert information. The management module 58 is coupled to the visualization mapping module 56. The management module 58 can receive the mapping indication, and generate a visual alert information indicative of the abnormal one among the sensed parameters/states on the basis of the mapping indication.

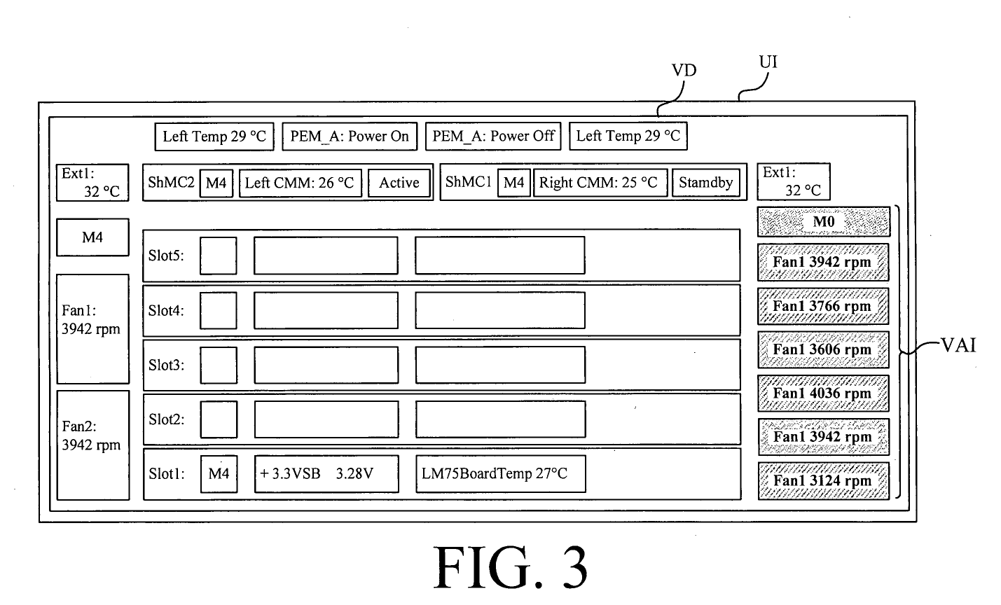

Please refer to FIG. 3. FIG. 3 shows the visual alert information VAI displayed in a user interface UI by a terminal apparatus 7 shown in FIG. 1. In actual applications, the terminal apparatus 7 is capable of communicating with the management module 58 to retrieve the visual alert information, and to display the visual alert information in a user interface. The terminal apparatus 7 can communicate with the management module 58 in a HyperText Transfer Protocol (HTTP). In other words, the terminal apparatus 7 can execute a browser to visit the management module 58 to retrieve the visual alert information. Then, the terminal apparatus 7 can, via the browser, display the visual alert information VAI in a user interface UI, as shown in FIG. 3. In actual applications, the user interface UI visually presents a physical structure of the plurality of components 10, and the visual alert information VAI is highlighted with an eye-catching color (represented as the dark area). Therefore, the user can view the visual alert information VAI to perceive the abnormal parameter/state and location of the related component 10 rapidly and intuitively, without looking up other reference data. It is noticeable that the user can also, via the user interface UI, do some management operations to the components 10 and the shelf management device 3, such as switching on/off or adjustment of working parameters.

For instance, when a fan component 10 of the multi-shelf modular computing system 1 is in an MO state, the shelf management device 3 can sense the MO state of the fan component 10 and responsively generate an original alert information in an SNMP trap format (as shown in FIG. 2A). Then, the receiving module 50 of the system management apparatus 5 can communicate with the shelf management device 3 to receive the original alert information from the shelf management device 3. Next, the parsing module 54 can parse the original alert information to generate a parsed alert information in a user-readable format (as shown in FIG. 2B), and store the parsed alert information into the storage module 52. Afterward, the visualization mapping module 56 periodically retrieves the parsed alert information, if any, from the storage module 52, and generates a mapping indication in accordance with the retrieved parsed alert information. Finally, the management module 58 can receive the mapping indication, and generate a visual alert information indicative of the MO state of the fan component 10 on the basis of the mapping indication. The user can operate the terminal apparatus 7 and visit the management module 58 with a browser to retrieve the visual alert information, and then the terminal apparatus 7 can, via the browser, display the visual alert information VAI in a user interface UI, as shown in FIG. 3. The user can view the visual alert information VAI to perceive the MO state of the fan component 10 rapidly and intuitively, so as to take corresponding measures.

The management module 58 can also communicate with the shelf management device 3 to receive the sensed parameters/states, and to generate a plurality of visual data representative of the sensed parameters/states. In practice, the management module 58 communicates with the shelf management device 3 in a Transmission Control Protocol (TCP) to receive the sensed parameters/states. Similarly, the terminal apparatus 7 can also communicate with the management module 58 to retrieve the visual data VD and display the visual data VD in the user interface UI, as shown in FIG. 3. Via the visual data VD, the user can easily monitor various parameters/states of the components 10 of the multi-shelf modular computing system 1, so as to achieve efficient management.

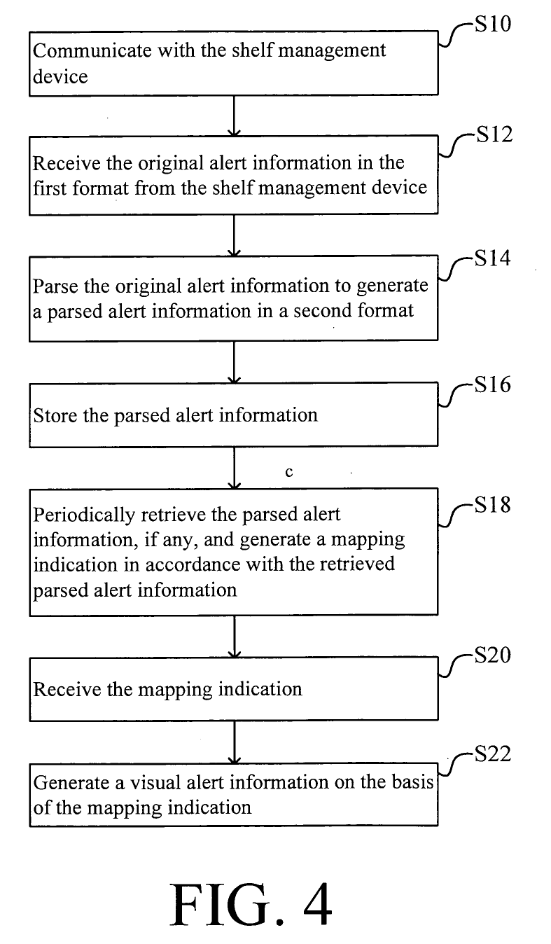

Please refer to FIG. 4 along with FIG. 1 through FIG. 3. FIG. 4 shows a flow chart of the system management method according to an embodiment of the invention. In the embodiment, the system management method is for a multi-shelf modular computing system 1. In practice, the multi-shelf modular computing system 1 can preferably, but not limited to, comply with an Advanced Telecom Computing Architecture (ATCA) specification which is a “carrier grade” communication equipment specification made by PCI Industrial Computer Manufacturers Group (PICMG). The multi-shelf modular computing system 1 includes a plurality of components 10 and a shelf management device 3. In actual applications, the components 10 can be the Field Replaceable Units (FRUs) of the multi-shelf modular computing system 1, such as single board computers, power supplies, fans, and thermal sensors. The shelf management device 3 is capable of sensing a plurality of parameters/states, which each relates to one of the components 10. In practice, the parameters/states include connection statuses of the single board computers, rotation rates of the fans, voltages of the power supplies, and the temperatures. The shelf management device 3 can also generate an original alert information in a first format in response to an abnormal one among the sensed parameters/states.

As shown in FIG. 4, the system management method according to the embodiment, firstly, performs step S10 to communicate with the shelf management device 3. In practice, the shelf management device 3 is communicated in a user datagram protocol or a transmission control protocol. Then, the system management method performs step S12 to receive the original alert information in the first format from the shelf management device 3. Next, the system management method performs step S14 to parse the original alert information to generate a parsed alert information in a second format. Afterward, the system management method performs step S16 to store the parsed alert information. In actual applications, the first format is a Simple Network Management Protocol (SNMP) trap format, and the second format is a user-readable format. For example, the original alert information in the first format, as shown in FIG. 2A, is difficult for people to understand. However, the parsed alert information, as shown in FIG. 2B, is more readable, but people still need to consult related reference data to more specifically understand the meaning of the parsed alert information. Then, the system management method performs step S18 to periodically retrieve the parsed alert information, if any, and to generate a mapping indication in accordance with the retrieved parsed alert information. Afterward, the system management method performs step S20 to receive the mapping indication. Finally, the system management method performs step S22 to generate a visual alert information indicative of the abnormal one among the sensed parameters/states on the basis of the mapping indication.

In practice, the system management method can further include the step of retrieving the visual alert information and displaying the visual alert information in a user interface UI which visually represents a physical structure of the plurality of components 10, as shown in FIG. 3. The user interface UI visually presents a physical structure of the plurality of components 10, and the visual alert information VAI is highlighted with eye-catching color (represented as the dark area). Therefore, the user can view the visual alert information VAI to perceive the abnormal parameter/state and location of the related component 10 rapidly and intuitively without looking up other reference data. In practice, the visual alert information VAI can preferably, but not limited to, comply with a web-page format.

In actual applications, the system management method can further include the step of communicating with the shelf management device 3 to receive the sensed parameters/states and generating a plurality of visual data representative of the sensed parameters/states. The shelf management device 3 can be communicated and the sensed parameters/states can be received in a TCP. In practice, the system management method can also retrieve the visual data VD and display the visual data VD in the user interface UI, as shown in FIG. 3. Via the visual data VD, the user can easily monitor various parameters/states of the components 10 of the multi-shelf modular computing system 1, so as to achieve efficient management. It is noticeable that the user can also, via the user interface UI, do some management operations to the components 10 and the shelf management device 3, such as switching on/off or making adjustment to working parameters.

Comparing to prior arts, the system management apparatus and method of the invention is for a multi-shelf modular computing system. At first, the system management apparatus receives and parses alert information associated with an abnormal parameter/state related to a component of the multi-shelf modular computing system, and stores the parsed alert information in a storage module. Afterward, the system management apparatus periodically retrieves the parsed alert information, if any, from the storage module, and generates a visual alert information indicative of the abnormal parameter/state. Thereby, a user can view the visual alert information to perceive the abnormal parameter/state rapidly and intuitively, so as to take corresponding measures. In addition, since the alert information can be stored in the storage module, a lot of alert information generated within a short time can be kept and earlier alert information will not be neglected. Furthermore, the system management apparatus can be web-based architecture with advantage of cross-platform capability which can lower the loading on client terminal apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system management apparatus for a multi-shelf modular computing system comprising a plurality of components and a shelf management device capable of sensing a plurality of parameters/states, which each relates to one of the components, and generating an original alert information in a first format in response to an abnormal one among the sensed parameters/states, said system management apparatus comprising:
a receiving module, capable of communicating with the shelf management device, for receiving the original alert information in the first format from the shelf management device;
a storage module;
a parsing module, coupled to the receiving module and the storage module, respectively, for parsing the original alert information to generate a parsed alert information in a second format, and storing the parsed alert information into the storage module;
a visualization mapping module, coupled to the storage module, for periodically retrieving the parsed alert information, if any, from the storage module, and generating a mapping indication in accordance with the retrieved parsed alert information; and
a management module, coupled to the visualization mapping module, for receiving the mapping indication, and generating a visual alert information indicative of the abnormal one among the sensed parameters/states on the basis of the mapping indication.

2. The system management apparatus of claim 1, wherein said multi-shelf modular computing system complies with an advanced telecom computing architecture specification.

3. The system management apparatus of claim 1, wherein the receiving module communicates with the shelf management device in a user datagram protocol or a transmission control protocol.

4. The system management apparatus of claim 1, wherein the first format is a Simple Network Management Protocol (SNMP) trap format.

5. The system management apparatus of claim 1, wherein second format is a user-readable format.

6. The system management apparatus of claim 1, wherein a terminal apparatus is capable of communicating with the management module to retrieve the visual alert information, and to display the visual alert information in a user interface.

7. The system management apparatus of claim 6, wherein the user interface visually presents a physical structure of the plurality of components.

8. The system management apparatus of claim 6, wherein the terminal apparatus communicates with the management module in a hypertext transfer protocol.

9. The system management apparatus of claim 1, wherein the management module is also capable of communicating with the shelf management device to receive the sensed parameters/states, and to generate a plurality of visual data representative of the sensed parameters/states.

10. The system management apparatus of claim 9, wherein the management module communicates with the shelf management device in a transmission control protocol to receive the sensed parameters/states.

11. A system management method for a multi-shelf modular computing system comprising a plurality of components and a shelf management device capable of sensing a plurality of parameters/states, which each relates to one of the components, and generating an original alert information in a first format in response to an abnormal one among the sensed parameters/states, said method comprising the steps of:
communicating with the shelf management device;
receiving the original alert information in the first format from the shelf management device;
parsing the original alert information to generate a parsed alert information in a second format;
storing the parsed alert information;
periodically retrieving the parsed alert information, if any, and generating a mapping indication in accordance with the retrieved parsed alert information;
receiving the mapping indication; and
generating a visual alert information indicative of the abnormal one among the sensed parameters/states on the basis of the mapping indication.

12. The system management method of claim 11, said multi-shelf modular computing system complies with an advanced telecom computing architecture specification.

13. The system management method of claim 11, wherein the shelf management device is communicated in a user datagram protocol or a transmission control protocol.

14. The system management method of claim 11, wherein the first format is a Simple Network Management Protocol (SNMP) trap format.

15. The system management method of claim 11, wherein the second format is a user-readable format.

16. The system management method of claim 11, further comprising the steps of:
retrieving the visual alert information; and
displaying the visual alert information in a user interface.

17. The system management method of claim 16, wherein the user interface visually represents a physical structure of the plurality of components.

18. The system management method of claim 16, wherein the visual alert information complies with a web-page format.

19. The system management method of claim 11, further comprising the steps of:
communicating with the shelf management device to receive the sensed parameters/states; and
generating a plurality of visual data representative of the sensed parameters/states.

20. The system management method of claim 19, wherein the shelf management device is communicated and the sensed parameters/states are received in a transmission control protocol.
